(19) United States
(12) Patent Application Publication
(10) Pub. No.: US 2022/0315343 A1
(43) Pub. Date: Oct. 6, 2022

(54) Chain Transport System

(71) Applicant: Hedrich GmbH, Ehringshausen-Katzenfurt (DE)

(72) Inventors: Joachim Schulz, Friedrichsdorf (DE); Gerhard Mais, Limburg (DE); Karl Bauch, Asslar (DE)

(73) Assignee: Hedrich GmbH, Ehringshausen-Katzenfurt (DE)

(21) Appl. No.: 17/623,661

(22) PCT Filed: Jul. 1, 2020
(86) PCT No.: PCT/EP2020/068553

§ 371 Date: Dec. 29, 2021

(30) Foreign Application Priority Data
Jul. 17, 2019 (DE) 10 2019 004 954.3

(51) Int. Cl. B65G 17/06

(52) U.S. Cl. CPC B65G 17/06

(57) ABSTRACT

A method and a device for transporting and driving components and tools, such as rotors and stators for manufacture, includes a component carrier with at least two chain sprockets rigidly connected to the component carrier. The chain sprockets engage four driven chains to move, rotate and swivel or rotated to a limited extent the component carrier. With the upper chain and lower chain moving at the same speed and in opposite directions of movement, the component carrier rotates on the spot, with the two chains moving at the same speed and in the same direction of movement, the component carrier moves without rotation at the chain speed in the direction of movement, and with the chains moving at different speeds and in the same or different directions of movement, a plurality of combinations of direction of rotation, direction of movement, transport speed and rotational speed can be achieved.

### CROSS-REFERENCE TO RELATED APPLICATIONS

This application is a national stage application (under 35 USC § 371) of PCT/EP2020/068553, filed Jul. 1, 2020, which claims benefit of DE 102019004954.3, filed Jul. 17, 2019, the contents of each of which is incorporated by reference herein.

### BACKGROUND OF THE INVENTION

### Field and State of the Art

The present invention relates to a method and to a device given by way of an example, especially for the rotating transport of components or tools (such as rotors and stators) along a chain track or belt track.

When it comes to impregnating the windings of stators and rotors, these items are sprinkled with impregnation resins or immersed into them. In order to ensure that these impregnation resins remain uniformly distributed over the whole extension and also to ensure that they do not drip off, the freshly impregnated components are imparted with an appropriate rotation and then gelled under heat and hardened. As a rule, the components are kept rotating even after the impregnation compound has solidified in order to attain a uniform heat distribution and later a uniform cooling off, thus preventing unnecessary stresses. The components are transported by means of a continuous or incremental advancing movement. During transport, it has to be taken into consideration that, if at all possible, only a few points of the components should come into contact with the transport means or with the component carriers.

Owing to the temperature stress and the aggressive vapors, existing installations for impregnating rotating components normally transport the components by means of a massive chain having pivot points into which component carriers, especially clamping mandrels, internal clamping chucks or similar clamping elements are secured, either permanently or detachably. The component carriers are rotatably mounted in the chain and have at least one sprocket with which they are made to rotate by means of a drive chain. If the component carriers are designed to be replaceable, then a sleeve which is mounted on bearings and which has an additional coupling site as well as a securing means are installed in the pivot point of the chain instead of the pivoted clamping mandrel. Owing to this design and to the resulting transport methods, the prior-art solutions are not flexible and do not permit different distances between the workpieces and thus no different retention times in the continuous furnaces and cooling sections. The prior-art mode of operation allows only one continuous chain per installation and thus prevents or impedes the possibility of a modular set-up of these installations. Resin vapors and resin drops are also highly problematic for bearings and coupling sites since they cause outages. Moreover, the massive chain involves a considerable construction effort.

When it comes to production machines that continuously rotate the components, Japanese published unexamined patent application JP 2000-117640 A puts forward a transport system for round components in which the components can be transported linearly while being imparted with a prescribed rotation. This document, however, does not propose a solution for oddly shaped components that can only be rotated by means of component carriers during the transport, that are mounted on bearings and that are precisely positioned.

Moreover, reference is hereby made to German patent application DE 25 14 792 A1, which describes a transport system for individuating components or packages. The proposed solution allows neither transport in a freely selectable direction of movement along with variable rotation of the components that are to be transported, nor does it allow the components to be mounted on bearings in such a way as to achieve contactless movement and rotation relative to the transportation path.

Before this backdrop, an objective of the invention is to create a flexible transport system that allows incremental as well as continuous transport in both directions while also being independent in terms of the speed and the direction of rotation. Moreover, the new system should not have any bearings between the chain and the clamping mandrel, and it should permit the components to be loaded and unloaded without the need for a coupling site. The distances between the clamping mandrels should be flexible and should be adaptable to the size of the components. The transport system should be modular, which means that the component carriers and thus the components can be transferred from the transport chain of one part of the installation to the transport chain of another part while being kept under continuous rotation.

### SUMMARY OF THE INVENTION

In the method according to the invention, the component carrier—usually a clamping or securing means for stators and rotors of electric motors—is rigidly joined to two sprockets. Each one of the two sprockets intermeshes with two opposite chains. In this context, the upper chains on both sprockets are preferably driven by drive sprockets that are rigidly situated on a drive axle. The same applies to the lower chains.

Thanks to this set-up, the proposed method allows the lower chains to move at a different speed and direction of movement than the upper chains. This translates into a transport method entailing the following possibilities:

While operating in the same direction of movement and at the same speed, the component carrier with the two sprockets is transported without rotation in the direction of movement of the chain.

While the upper and lower chains are operating in opposite directions of movement and at the same speed, the component carrier rotates without departing from its position. The direction of rotation can be reversed by reversing the direction of movement of the chain.

If the upper and lower chains are moving at different speeds and, optionally, also in the same direction or in different directions, then all combinations of advancing movement and rotation can be generated. Consequently, the direction of rotation of the workpiece, its speed, the direction of transport and the speed of transport can all be varied at any point in time.

The component carrier does not need a bearing, be it for the transport or for the rotation. The sprockets themselves function as a drive and as a bearing at the same time.

The new method also allows component carriers that are holding workpieces to be loaded and unloaded without a coupling site, for instance, by changing the distance between the upper and lower chains. Since the rotating component carriers are not permanently integrated into the chains, as has been the case up until now, the distances from one component carrier to another component carrier can be varied as desired, taking into consideration the size of the workpiece and the size of the sprocket.

This allows adaptation to different component carriers and workpiece sizes. The proposed method with the appertaining set-up also allows rotating component carriers with components to be transferred from one chain drive to another without interrupting the rotation, so that entire transport systems can be set up. Moreover, while the components that are to be produced are kept under constant rotation, it is possible to create a modular set-up of installations since each module can have its own transport means for the rotating workpieces.

The method described on the basis of chains and sprockets is likewise conceivable with belts, especially toothed belts and belt pulleys. It does not rule out cables and cable pulleys.

The device for carrying out the method is described on the basis of chains and sprockets since it is easy to make these elements out of heat-resistant and chemical-resistant materials and they are thus especially well-suited for furnaces and chemical substances. In particular, the proposal is made to use chains, which have a long service life and can be operated without the use of lubricants. For cases involving high stress, especially triplex chains are proposed; these are triple chains that have the usual divisions of, for example, ½ inch, ¾ inch and 1 inch, with three rollers distributed over the width and over the in-between connecting links. It is proposed for the sprockets of the component carriers to be allowed to run in the center row of chains and for the drive sprockets as well as the deflection sprockets to engage as double sprockets into the outer rows of chains. As an alternative, the chain rollers on the outer rows of chains can also serve to introduce a force into the deflection radii and guide rails. If only narrow connecting links are employed on the outer side of the chain, the rollers of the outer tracks serve as bearings for guiding the chain, for example, in guide rails. Thanks to the distribution of the tracks, there is no reciprocal impairment of the fixed drive and the guide elements with the mobile component carriers.

If the transport line and thus the chains have a meandering layout, care should be taken to ensure that the distance between the two chains that act upon a sprocket of the component carrier remains the same throughout. In the case of straight sections, especially with a horizontal layout, this can be assisted by support rails or guide rails. On curves, the inner chains can be appropriately guided by sprockets while the outer chains can be guided by guide rails having an appropriate radius.

For purposes of a controlled transfer of a component carrier with sprockets from one transport unit to another, the double sprockets should be chosen so as to be as small as possible so that the sprockets of the component carrier remain engaged at all times. It is likewise suggested for the transition from upper chain to upper chain and from lower chain to lower chain to be offset by the transition width. In addition, it is recommended for sliding rails, which secure the position of the component carrier between the chains, to be installed at the transition site.

The upper and lower chains are driven separately. The drives are preferably situated at the end of the conveying section. Chain tensioners are proposed which act in pairs on the slack half of the chain.

(For purposes of achieving a better utilization of spaces when a meandering chain layout is being implemented, preference should be given to a vertical layout over a horizontal one since the mass of the component carriers and the weight of the workpieces as well as the resultant torques all act upon the chain essentially as tensile forces and not as flexural forces.)

The component carrier preferably consists of a tube onto whose outside two sprockets are secured at a suitable distance. Inside, there is a securing means that projects outwards on one side and that is preferably actuated from the opposite side. Optionally, there are also securing means on both ends of the component carrier, which brings about a more uniform stress of the component carrier and of the chains while also doubling the transport capacity.

The proposed method and the device can also be implemented with a single-track roller chain, with round steel chains and with belts, especially toothed belts. In the case of a round steel chain, the pocket wheels are employed as drive sprockets and deflection sprockets, whereas the component carrier has wheels that engage with the links of the round steel chain.

At least a few individual component carriers can be fitted with tools such as brushes, grinding elements or nozzles instead of with components, and, due to the possible rotatory drive, they can perform work along the line. Thus, for example, while a component is being heated up in a continuous furnace, it can be brushed at the same time. The component carrier itself can be configured as a tool.

Additional objectives, advantages, features and application possibilities of the present invention ensue from the description below of an embodiment making reference to the drawing. In this context, all of the described and/or depicted features, either on their own or in any meaningful combination, constitute the subject matter of the present invention, also irrespective of their compilation in the claims or the claims to which they refer back.

### DESCRIPTION OF THE DRAWINGS

FIG. 1 shows a simplified transport system consisting of transport units in the main view,

FIG. 2 shows a simplified transport system in a side view,

FIG. 3 shows a component carrier by way of an example, with a component placed on it, and

FIG. 4 shows the offset transition from the upper chain and the lower chain between two transport units with a triple chain.

### DETAILED DESCRIPTION

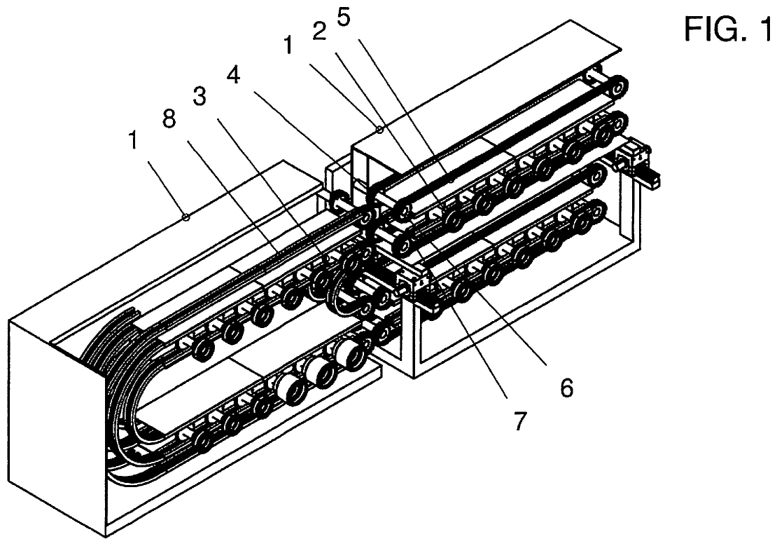

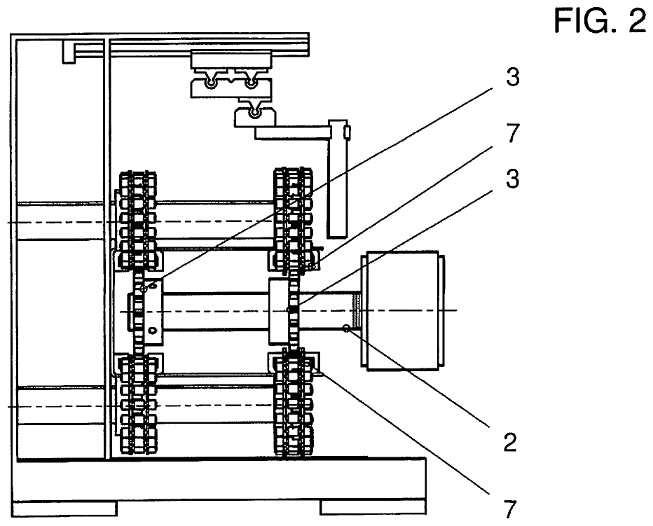

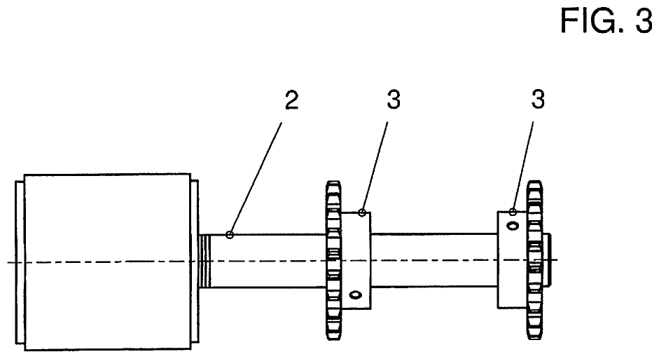

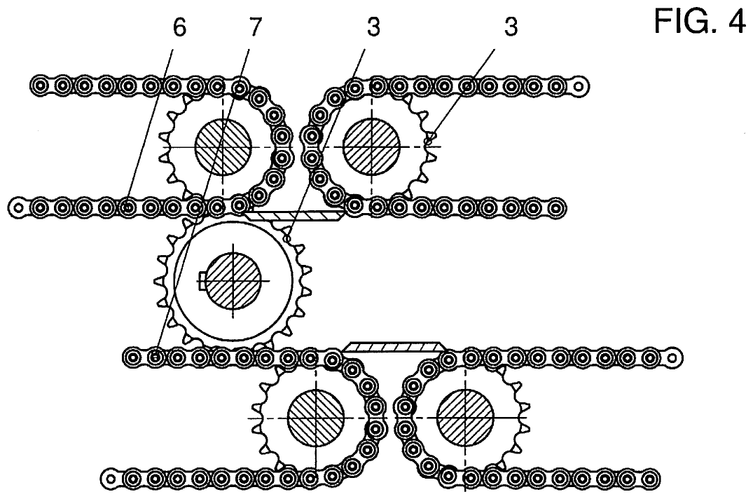

The method according to the invention and a device according to the invention given by way of an example are described below making reference to FIGS. 1 to 4.

Up until now, components—especially stators and rotors of electric motors that are rotated continuously during impregnation with resin and during the subsequent gelling and hardening in order to prevent the liquid resin from dripping off or being unevenly distributed—have been moved continuously or incrementally from one station to the next by a securing means that is mounted on roller bearings or sliding bearings and, in this process, they are made to rotate by an additional chain drive.

For the first time, the new method for transporting components by means of component carriers 2 while under continuous rotation allows both functions to be fulfilled without the need to use bearings for this purpose. In addition, up until now, solutions involving replaceable component carriers called for special couplers and actuators for coupling and de-coupling in order to carry out the replacement and also called for additional actuation mechanisms for the coupling. This function is also easily available with the new method in that the component carrier 2 that is rigidly connected to at least two sprockets 3 is situated between four chains, preferably triple chains 5, and in that it can enter or exit at the end of a conveying line or else this can be done by increasing the chain distance. All of the forces and torques that act upon the component carrier 2 are absorbed by the four triple chains 5 that position the component carrier 2. Thanks to two separately driven chain pairs, two upper chains 6 on one side of the sprockets 3 and two lower chains 7 on the other side, the new method allows a variable number of component carriers 2 to be accommodated, transported and driven. This only functions because it is possible to have a variable distance between the component carriers 2.

The use of triple chains 5 makes it possible to prevent the stationary drive sprockets and the deflection sprockets as well as the guide rails from colliding with the mobile sprockets of the component carrier or tool, and this is achieved in that the drive sprockets and the deflection sprockets are double sprockets 4 that engage with the outer tracks while the sprockets 3 on the component carriers 2 engage with the center track.

If a single-track upper chain 6 and lower chain 7 are being used, then either the drive sprockets and deflection sprockets that are passed by the component carrier 2 or else the sprockets 3 that are secured on the component carrier 2 have to be configured as pocket wheels in order to rule out contact between the stationary wheels and the moving wheels.

Owing to the different direction of movement and speed of the upper chains 6 and the lower chains 7, the proposed method based on the special set-up of the proposed chain transport system allows the movements presented below for the component carrier 2 or for a correspondingly used tool.

The upper chain 6 and the lower chain 7 are moving in the same direction and at the same speed. This translates into a transport of the component carrier 2 in the direction of movement of the chains at the chain speed and without rotation.

The upper chain 6 and the lower chain 7 are moving in opposite directions at the same speed. This translates into a pure rotation of the component carrier 2 without further transport of the component carrier 2.

The upper chain 6 and the lower chain 7 are moving in opposite directions at different speeds. The difference in the speed yields the transport speed of the component carrier 2. The direction of movement is dependent on the direction of movement itself plus on whether it is the upper chain 6 or the lower chain 7 that is running faster. The rotational speed results from the speed of the slower chain, as a function of the diameter of the sprocket 3 on the component carrier 2, while the direction of rotation results from the direction of movement.

The upper chain 6 and the lower chain 7 are moving in the same direction at different speeds. The difference in the speed yields the rotational speed as a function of the diameter of the sprocket 3 on the component carrier 2. The direction of movement of the component carrier 2 results from the direction of movement of the chains. The speed of the component carrier 2 results from the speed of the slower chain plus the difference in the speed between the upper chain 6 and the lower chain 7 divided by u.

The proposed method and design allow component carriers 2, tools and components to be loaded and loaded without the need for separating sites and coupling sites. The capability to transfer component carriers 2 from one transport unit 1 to the next one by simply exiting one chain system and subsequently or simultaneously entering the next chain system, permits continuous transport of the components without the need for handling equipment such as robots throughout various installation parts or transport units 1. For the first time, this allows a modular set-up of an installation with chain conveyance while the components or tools are continuously rotating.

The forces and torques that act upon the component carrier 2 without bearings can be absorbed by the permanent connection of two sprockets 3 to the component carrier 2 at the distance of the two upper chains 6 and the two lower chains 7 since these engage with the opposite upper chains 6 and lower chains 7 that are at the distance of the sphere of influence of the sprocket 3.

A slightly slanted positioning of the component carrier 2 can be permanently achieved by an offset orientation of the teeth of the two sprockets 3 on the component carrier 2 and this can also be done temporarily by slightly shifting the rear upper chain 6 and lower chain 7 relative to the front chains.

A slight inclination of the component carrier 2 can be implemented, for example, by slightly raising the rear chains and correspondingly lowering the front chains.

In order to ensure an uninterrupted drive at the transition from one transport unit 1 having a chain drive to another transport unit 1 having its own chain system, it is necessary to have the right size ratios between the deflection sprockets and the sprocket 3 that is situated on the component carrier 2, so that the chain of the next transport unit 1 is already engaged before the chain of the upstream transport unit 1 has been disengaged. A smooth transition can be effectuated by offsetting the transition between the upper chains 6 to the lower chains 7 and/or by additionally installing sliding rails 9 that keep the component carrier 2 on course.

In the case of the preferred vertical layout of the chains, only deflection elements in the form of sprockets and arched sliding rails 9 are needed at the deflection sites. In the case of a horizontal layout of the chains, it is advisable to use sprockets or guide rails at regular intervals for purposes of positioning the chains.

### LIST OF REFERENCE NUMERALS

1 transport unit
2 component carrier
3 sprocket
4 double sprocket
5 triple chain
6 upper chain
7 lower chain
8 guide rail
9 sliding rail

1.-12. (canceled)

13. A device for flexibly transporting stators and rotors for processing while said stators and rotors are rotating, comprising:
a component carrier having bearing sites each configured to receive a respective one stator or one rotor, said component carrier further having drive elements in the form of at least two sprockets that are permanently positioned at a distance from each other; and
four driven chains that include upper chains as well as lower chains, wherein said upper chains and said lower chains have a shared drive axle and separate drives; and
wherein each sprocket engages with one upper chain and with one lower chain.

14. The device according to claim 13, further comprising: guide rails and double sprockets as guide elements for the chains.

15. The device according to claim 13, further comprising: a manually or automatically actuated chain-positioning means for compensating chain length of either the upper chains and/or the lower chains.

16. The device according to claim 15, wherein the chain-positioning means is located where the stators and rotors are loaded onto a transport unit or where the stators and rotors are unloaded from the transport unit.

17. The device according to claim 13, further comprising several independent, modularly structured transport units through which one or more component carriers can pass, wherein transition sites on the lower chains are arranged offset to transition sites of the upper chains, and further comprising sliding rails secured as transition elements at the transition sites from one chain to another chain.

18. The device according to claim 13, wherein the chains are triple roller chains, and wherein the sprockets comprise drive sprockets and deflection sprockets that engage through a double sprocket into the outer tracks of the triple roller chains, and the sprocket on the component carrier engages into the center track of the triple roller chains, and wherein the outer roller tracks run in guide tracks and on support rails.

19. The device according to claim 13, wherein the chains are single-track chains, and wherein the sprockets are formed on the component carrier as pocket wheels.

20. The device according to claim 13, wherein the component carrier further comprises at least one positioning and/or clamping means with manual or automatic actuation.

21. The device according to claim 20, wherein the clamping means comprises has an energy storage means in the form of a spring.

22. The device according to claim 13, wherein the component carrier is equipped with automatic or manual tool coupling sites,

23. The device according to claim 13, wherein the component carrier is replaced by a tool on which the sprockets are secured.

24. The device according to claim 13, wherein the chains are replaced by belts or double toothed belts, and the sprockets are replaced by belt pulleys.

25. The device according to claim 13, wherein the chains are replaced by cables and the sprockets are replaced by cable pulleys.

26. The device according to claim 13, further comprising a tool selected from the group consisting of: a brush, a grinder, and a nozzle, wherein said tool is received in the bearing site of one component carrier instead of the rotor or stator.

27. A method for transporting and driving rotors and/or stators with the device of claim 1, comprising:
selectively bearing, driving and positioning the component carrier via the at least two sprockets engaged with the four driven chains to shift, rotate and/or swivel the component carrier and the rotors and/or stators removably attached thereto.

28. The method of claim 27, further comprising controlling direction of movement, transport speed and rotational speed of the component carrier by controlling movement of the upper chains and the lower chains, wherein the drive sprockets for the two upper chains and for the two lower chains are each situated on one axle and each have their own drive, and wherein the drives for the upper chains and the lower chains are configured to permit different directions of rotation and different rotation speeds, so that if the upper chains and the lower chains are moving at the same speed and in opposite directions of movement, the component carrier rotates in a stationary spot, and if the upper chains and the lower chains are moving at the same speed and in the same direction of movement, the component carrier is transported without rotation at the speed of the chain in the direction of movement, and, if the upper chains and the lower chains are moving at different speeds and in the same direction or in different directions of movement, then a plurality of combinations of the direction of rotation, the direction of movement, the transport speed and the rotational speed are implemented.

29. The method of claim 27, further comprising: cleaning, coating or processing the stators and rotors while secured by the component carrier as the component carrier is transported through an applicable cleaning, coating or processing section.

30. The method of claim 29, further comprising: gelling the stators and rotors while secured by the component carrier as the component carrier is transported through an applicable gelling section; and
hardening the stators and rotors while secured by the component carrier as the component carrier is transported through an applicable hardening section.

31. The method of claim 30, further comprising: cooling the stators and rotors while secured by the component carrier.

32. The method of claim 29, further comprising: cleaning, coating or processing additional stators and rotors while secured by a second component carrier as the second component carrier is transported through an applicable cleaning, coating or processing section with said second component carrier spaced apart from the initial component carrier at a pre-selectable distance.
